(19) United States
(12) Patent Application Publication
(10) Pub. No.: US 2011/0109983 A1
(43) Pub. Date: May 12, 2011

(54) LENS CONNECTOR

(75) Inventors: Chun-Wei LU, TAIPEI HSIEN (TW); Hao-Chuan CHAO, TAIPEI HSIEN (TW)

(73) Assignee: AVERMEDIA INFORMATION, INC., TAIPEI HSIEN (TW)

(21) Appl. No.: 12/692,654

(22) Filed: Jan. 25, 2010

(30) Foreign Application Priority Data
Nov. 11, 2009 (TW) 98138304

(51) Int. Cl. G02B 7/02

(52) U.S. Cl. 359/827

(57) ABSTRACT

A lens connector is provided. The lens connector connects a document camera and a microscope. The lens connector comprises a lapping part and a cylindrical sleeve. The lapping part comprises a microscope eyepiece lapping end and a DC lens lapping end. A plurality of elastic pieces are formed on the microscope eyepiece lapping end, wherein an outer screw thread is formed on an outer sidewall of the elastic pieces. The DC lens lapping end connects the lens of the DC. The cylindrical sleeve comprises an axial through-hole, wherein an inner screw thread is formed along axial through-hole. The inner screw to thread of the cylindrical sleeve is adapted to the outer screw thread of the elastic pieces such that when the cylindrical sleeve rotates in a specific direction, the elastic pieces are simultaneously bent to fasten the eyepiece of the microscope.

### RELATED APPLICATIONS

This application claims priority to Taiwan Application Serial Number 98138304, filed Nov. 11, 2009, which is herein incorporated by reference.

### BACKGROUND

1. Technical Field

The present disclosure relates to an optical device. More particularly, the present disclosure relates to a lens connector.

2. Description of Related Art

Document cameras (DC) are electronic devices that capture real-time images to show an object to a large audience. By placing the object on the baseboard of the document camera and under the high-resolution web cams, the digital image of the object can be obtained. In a specific application, the microscope can be adapted to the document camera through a connector. Therefore, what is observed by the microscope can be presented as digital image through the document camera.

However, the conventional connector makes use of a plurality of screws to fasten the document camera and the microscope. If the fastening positions of the screws are not identical, the optical axis of the microscope will deviate from the optical axis of the document camera such that the document camera is not able to completely demonstrate what is observed by the microscope. In addition, the position and the diameter of the exit pupils of the eyepieces of different microscopes are different as well. A complex tuning mechanism is needed for the document camera to match the different microscopes.

Accordingly, what is needed is a lens connector to make the optical axis of the document camera in precise alignment with the optical axis of the microscope and to provide a simple tuning mechanism to tune the exit pupil. The present disclosure addresses such a need.

### SUMMARY

An aspect of the present disclosure is to provide a lens connector to connect a document camera and a microscope, wherein the lens connector comprises: a lapping part and a cylindrical sleeve. The lapping part comprises a microscope eyepiece lapping end and a DC lens lapping end. The microscope eyepiece lapping end comprises a plurality of elastic pieces, wherein an outer screw thread is formed on an outer sidewall of the elastic pieces. The DC lens lapping end connects the lens of the document camera. The cylindrical sleeve comprises an axial through-hole, wherein an inner screw thread is formed along the axial through-hole, the inner screw thread of the cylindrical sleeve is adapted to the outer screw thread of the elastic pieces such that when the cylindrical sleeve rotates in a specific direction, the elastic pieces are simultaneously bent to fasten an eyepiece of the microscope.

Another aspect of the present disclosure is to provide a lens connector to connect a document camera and a microscope, wherein the lens connector comprises: a lapping part and a cylindrical sleeve. The lapping part comprises a first lapping part, a second lapping part and a group of lens. A microscope eyepiece lapping end comprising a plurality of elastic pieces is formed on the first lapping part and an outer screw thread is formed on an outer sidewall of the elastic pieces. The second lapping part is to be connected to the first lapping part, wherein the DC lens lapping end is formed on the second lapping part to connect the lens of the document camera. The group of lenses is placed between the first and the second lapping parts when the first and the second lapping parts are connected to each other to change the position and the diameter of the exit pupil of an eyepiece of the microscope. The cylindrical sleeve comprises an axial through-hole, wherein an inner screw thread is formed along the axial through-hole, the inner screw thread of the cylindrical sleeve is adapted to the outer screw thread of the elastic pieces such that when the cylindrical sleeve rotates in a specific direction, the elastic pieces are simultaneously bent to fasten the eyepiece of the microscope.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a 3-D view of the lens connector of an embodiment of the present disclosure;

FIG. 1B is a perspective side view of the lapping part and the cylindrical sleeve in FIG. 1A when they are connected to each other;

FIG. 2A is a 3-D view of the lens connector of an embodiment of the present'disclosure; and

FIG. 2B is a perspective side view of the lapping part and the cylindrical sleeve in FIG. 2A when they are connected to each other.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

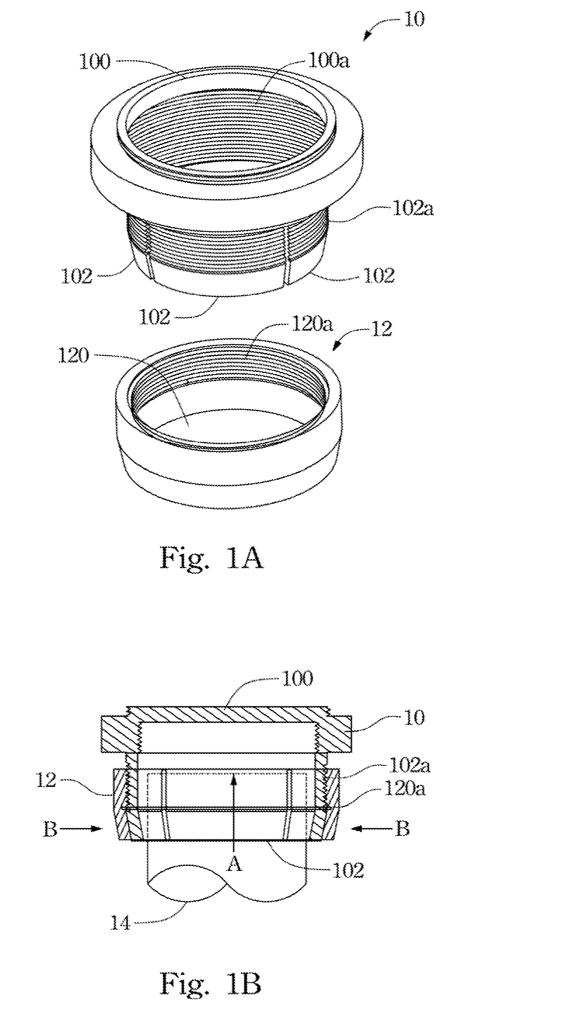

Please refer to FIG. 1A. FIG. 1A is a 3-D view of the lens connector 1 of an embodiment of the present disclosure. The lens connector 1 connects a document camera (DC) and a microscope (not shown). The lens connector 1 comprises: a lapping part 10 and a cylindrical sleeve 12. The lapping part 10 comprises a microscope eyepiece lapping end and a DC lens lapping end 100. The microscope eyepiece lapping end connects an eye piece 14 (depicted in FIG. 1B) of the microscope, and the DC lens lapping end 100 connects the lens (not shown) of the DC. The microscope eyepiece lapping end comprises a plurality of elastic pieces 102, wherein an outer screw thread 102a is formed on an outer sidewall of the elastic pieces 102. In different embodiments, the number of the elastic pieces 102 can be different as well. The elastic pieces 102 are made of metal, plastic or other kinds of elastic material.

The cylindrical sleeve 12 comprises an axial through-hole 120, wherein an inner screw thread 120a is formed on the surface of the axial through-hole 120. Please refer to FIG. 1B. FIG. 1B is a perspective side view of the lapping part 10 and the cylindrical sleeve 12 in FIG. 1A when they are connected to each other. The inner screw thread 120a of the cylindrical sleeve 12 can be adapted to the outer screw thread 102a of the elastic pieces 102 such that when the cylindrical sleeve 12 rotates in a specific direction, the cylindrical sleeve 12 moves along the direction A depicted in FIG. 1B. The movement of the cylindrical sleeve 12 makes the elastic pieces 102 formed on it simultaneously bend toward the central part of the microscope eyepiece lapping end, i.e. the direction B depicted in FIG. 1B.

The bent elastic pieces 102 are able to fasten the eyepiece 14 of the microscope. On the other hand, the DC lens lapping end 100 laps the lens of the DC. In the present embodiment, the inner surface of the DC lens lapping is end 100 has an inner screw thread 100a to be adapted to a corresponding outer screw thread of the lens of the DC. In other embodiments, a different lapping mechanism can be used for the connection of the DC lens and the DC lens lapping end 100 without changing the optical axis of the camera.

Thus, after the rotation, the cylindrical sleeve 12 and the lapping part 10 are connected to each other and the elastic pieces 102 are bent simultaneously to catch the eyepiece 14 of the microscope. Besides making the axes of the eyepiece 14 and the cylindrical sleeve 12 align to each other, the alignment of the optical axes of the eyepiece 14 and the DC can be maintained as well. In other words, the alignment of the optical axes can be maintained after the connection of the DC and the microscope through the lens connector 1. Further, the lens connector 1 can adjust the distance between the eyepiece 14 and the DC to complete transfer what is observed from the microscope to the digital image of the DC.

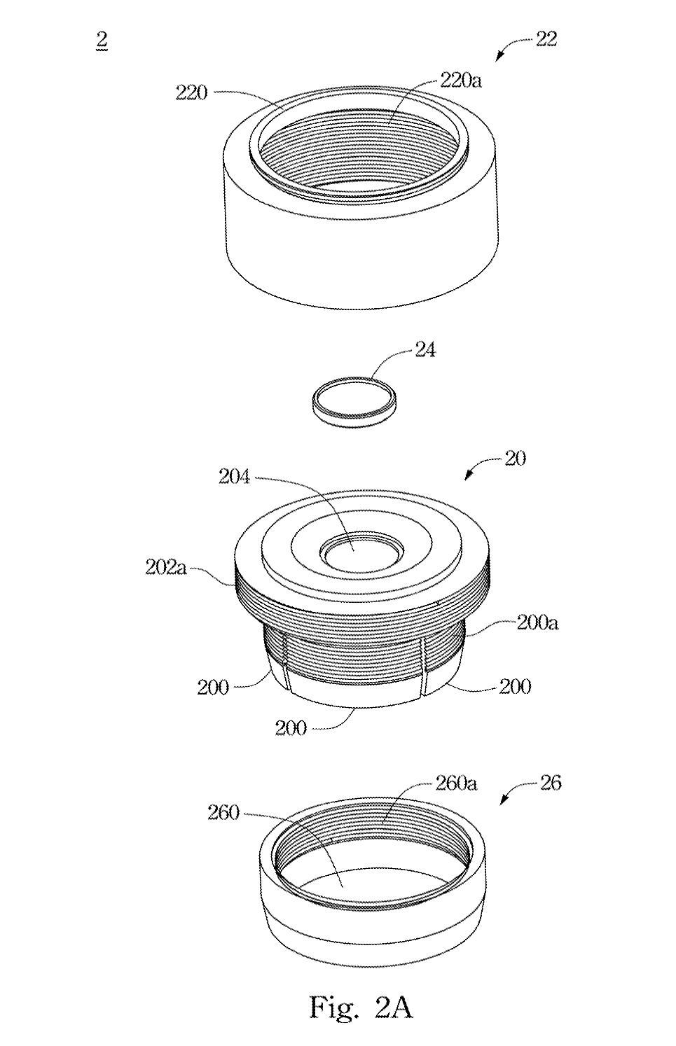

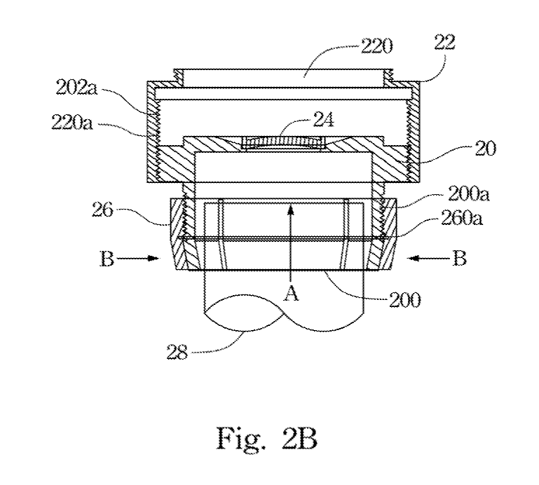

Please refer to FIG. 2A. FIG. 2A is a 3-D view of the lens connector 2 of another embodiment of the present disclosure. The lens connector 2 connects a document camera (DC) and a microscope (not shown). The lens connector 2 comprises: a lapping part and a cylindrical sleeve 26. The lapping part comprises a first lapping part 20, a second lapping part 22 and a group of lenses 24.

The first lapping part 20 comprises a microscope eyepiece lapping end to be connected to the eyepiece 28 (depicted in FIG. 2B) of the microscope. A plurality of elastic pieces 200 are formed on the microscope eyepiece lapping end and an outer screw thread 200a is formed on an outer sidewall of the elastic pieces 200. In different embodiments, the number of the elastic pieces 200 can be different as well. The elastic pieces 200 are made of metal, plastic or other kinds of elastic material.

The second lapping part 22 comprises a DC lens lapping end 220. The DC lens lapping end 220 connects the lens of the document camera. The second lapping part 22 is able to be connected to the first lapping part 20. In the present embodiment, the first lapping part 20 not only comprises an outer screw thread 200a on the outer sidewall of the elastic pieces 200, but also comprises an outer screw thread 202a on the other end. The second lapping part 22 comprises an inner screw thread 220a. The second lapping part 22 can thus be connected to the DC lens on one end and be connected to the first lapping part 20 on the other end.

When the first and the second lapping parts 20 and 22 are connected to each other, a containing space is formed, wherein the group of lens 24 can be embedded in the containing space. In the present embodiment, the containing space is a fillister 204.

The cylindrical sleeve 26 comprises an axial through-hole 260, wherein an inner screw thread 260a is formed along the axial through-hole 260. Please refer to FIG. 2B. FIG. 2B is a perspective side view of the lapping part 20 and the cylindrical sleeve 26 in FIG. 2A when they are connected to each other. The inner screw thread 260a of the cylindrical sleeve 26 can be adapted to the outer screw thread 200a of the elastic pieces 200 such that when the cylindrical sleeve 26 rotates in a specific direction, the cylindrical sleeve 26 moves along the direction A depicted in FIG. 2B. The movement of the cylindrical sleeve 26 makes the elastic pieces 102 formed on it simultaneously bent toward the central part of the microscope eyepiece lapping end, i.e. the direction B is depicted in FIG. 2B.

The bent elastic pieces 200 are able to fasten the eyepiece 28 of the microscope. On the other hand, the DC lens lapping end 220 of the second lapping part 22 laps the lens of the DC.

Thus, after the rotation, the cylindrical sleeve 26 and the lapping part are connected to each other and the elastic pieces 200 are bent simultaneously to catch the eyepiece 28 of the microscope. Besides making the axes of the eyepiece 28 and the cylindrical sleeve 26 align to each other, the alignment of the optical axes of the eyepiece 28 and the DC can be maintained as well. In other words, the alignment of the optical axes can be maintained after the connection of the DC and the microscope through the lens connector 2. Further, the lens connector 2 can adjust the distance between the eyepiece 28 and the DC to complete transfer what is observed from the microscope to the digital image of the DC. Further, the group of lens 24 provides a tuning mechanism to tune the position and the diameter of the exit pupil of the eyepiece 28 of the microscope. For different eyepieces of different microscope, it's easy to change or adjust the composition of the group of lens 24 to make the image of the object observed in the microscope form at an appropriate position, such that the DC can output a better quality of the image.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A lens connector to connect a document camera and a microscope, wherein the lens connector comprises:
a lapping part comprising:
a microscope eyepiece lapping end comprising a plurality of elastic pieces, wherein an outer screw thread is formed on an outer sidewall of the elastic pieces; and
a DC lens lapping end to connect the lens of the document camera;
and
a cylindrical sleeve comprising an axial through-hole, wherein an inner screw thread is formed along the axial through-hole, the inner screw thread of the cylindrical sleeve is adapted to the outer screw thread of the elastic pieces such that when the cylindrical sleeve rotates in a specific direction, the elastic pieces are simultaneously bent to fasten an eyepiece of the microscope.

2. The lens connector of claim 1, wherein lapping part further comprises:
a first lapping part, wherein the microscope eyepiece lapping end is formed on the first lapping part;
a second lapping part to be connected to the first lapping part, wherein the DC lens lapping end is formed on the second lapping part; and
a group of lens placed between the first and the second lapping parts when the first and the second lapping parts are connected to each other to change the position and the diameter of the exit pupil of the eyepiece of the microscope.

3. The lens connector of claim 2, wherein the group of lens is embedded in a containing space formed when the first and the second lapping parts are connected to each other.

4. The lens connector of claim 1, wherein the plurality of elastic pieces are metal or plastic.

5. A lens connector to connect a document camera and a microscope, wherein the lens connector comprises:
a lapping part comprising:
a first lapping part, wherein a microscope eyepiece lapping end comprising a plurality of elastic pieces is formed on the first lapping part and an outer screw thread is formed on an outer sidewall of the elastic pieces;
a second lapping part to be connected to the first lapping part, wherein the DC lens lapping end is formed on the second lapping part to connect the lens of the document camera; and
a group of lenses placed between the first and the second lapping parts when the first and the second lapping parts are connected to each other to change the position and the diameter of the exit pupil of an eyepiece of the microscope; and
a cylindrical sleeve comprising an axial through-hole, wherein an inner screw thread is formed along the axial through-hole, the inner screw thread of the cylindrical sleeve is adapted to the outer screw thread of the elastic pieces such that when the cylindrical sleeve rotates in a specific direction, the elastic pieces are simultaneously bent to fasten the eyepiece of the microscope.

6. The lens connector of claim 5, wherein the group of lens is embedded in a containing space formed when the first and the second lapping parts are connected to each other.

7. The lens connector of claim 5, wherein the plurality of elastic pieces are metal or plastic.
